(19) United States
(12) Patent Application Publication
(10) Pub. No.: US 2025/0286415 A1
(43) Pub. Date: Sep. 11, 2025

(54) STATOR

(71) Applicant: MCF Electric Drive Corporation, Hiroshima City (JP)

(72) Inventor: Naoki ITASAKA, Hiroshima City (JP)

(21) Appl. No.: 18/986,435

(22) Filed: Dec. 18, 2024

(30) Foreign Application Priority Data
Mar. 5, 2024 (JP) 2024-033420

(51) Int. Cl. H02K 1/20; H02K 9/19

(52) U.S. Cl. CPC H02K 1/20; H02K 9/19

(57) ABSTRACT

A stator including: a stator core having a cylindrical shape and having a plurality of slots; and coils attached to the stator core by being inserted into the plurality of slots, wherein the plurality of slots each have inner walls including: a pair of side walls which extend radially outward from an inner circumference part of the stator core such that a corresponding one of the plurality of slots is open radially inward, the pair of side walls circumferentially facing each other; and a bottom wall connected to an end of each of the pair of side walls. In each of the plurality of slots, an outer coil arranged radially outermost among the coils is arranged radially apart from the bottom wall such that a space is provided between the bottom wall and the outer coil, and the space forms an in-core flow path through which a cooling medium flows.

### CROSS-REFERENCE TO RELATED APPLICATIONS

The present application claims priority to JP application No. 2024-33420, filed Mar. 5, 2024, the disclosure of which is incorporated herein by reference in its entirety.

### TECHNICAL FIELD

The present disclosure relates to a stator of a motor, particularly, of a permanent magnet motor.

### BACKGROUND OF THE DISCLOSURE

Along with recent popularization of electric vehicles, downsizing of a motor is required in terms of mounting of the motor, an increase in types, manufacturing, cost reduction, and the like of the electric vehicles. To downsize the motor without reducing power of the motor, a power density of the motor has to be increased, and more specifically, a current density of a current caused to flow thorough a coil has to be increased. However, when the current density is increased, the amount of heat generation of the coil increases, and therefore, a technique of cooling the coil and a peripheral part (e.g., the interior of the stator core) of the coil becomes important. JP 2022-182069 discloses a technique of disposing metal pipes through which a cooling medium flows in a slot of a stator core to cool the stator core and the coil.

The technique disclosed in JP 2022-182069 requires a process of attaching the pipes in the slot, and therefore, complication of the production process of the stator is concerned, and since the cooling medium cools the stator core and the coil indirectly through the pipes, and therefore, the technique is still susceptible to an improvement in efficiently cooling the coil and the stator core.

### SUMMARY

In view of the foregoing, it is an object of the present disclosure to provide a stator configured such that a stator core and a coil of the stator are efficiently cooled while the stator is manufacturable in a further simplified manner.

To achieve the object, a stator according to the present disclosure has the following configuration. The stator according to the present disclosure includes a stator core having a circularly cylindrical shape and having a plurality of slots axially penetrating the stator core, and coils attached to the stator core by being inserted into the plurality of slots. The plurality of slots each have inner walls including: a pair of side walls which extend radially outward from an inner circumference part of the stator core such that a corresponding one of the plurality of slots is open radially inward, the pair of side walls circumferentially facing each other; and a bottom wall connected to an end of each of the pair of side walls. In each of the plurality of slots, an outer coil arranged radially outermost among the coils is arranged radially apart from the bottom wall such that a space is provided between the bottom wall and the outer coil, and the space forms an in-core flow path through which a cooling medium flows.

With this configuration, the plurality of slots each have inner walls including: the pair of side walls which extend radially outward from the inner circumference part of the stator core such that a corresponding one of the plurality of slots is open radially inward, the pair of side walls circumferentially facing each other; and the bottom wall connected to an end of each of the pair of side walls, and thereby, an open part is provided radially inner side of each slot, and a closed part closed by the pair of side walls and the bottom wall is provided radially outer side of each slot. Such a closed part is provided for each of the plurality of slots, and in each of the plurality of slots, the outer coil arranged radially outermost among the coils is arranged radially apart from the bottom wall such that the space is provided between the bottom wall and the outer coil, and thereby, the closed part (the pair of side walls and the bottom wall) and a radially outside part of the outer coil defines the space.

The space thus defined forms an in-core flow path through which the cooling medium flows, and thereby, without attaching another member (e.g., a pipe) in the slot, the in-core flow path can be provided in the stator core. Thus, the stator including the stator core with the in-core flow path formed therein can be manufactured in a further simplified manner.

Further, the space forms the in-core flow path, and thereby, the cooling medium flowing through the in-core flow path (the space) comes into contact with the stator core at the closed part defining the space and comes into contact with the coils at the radially outside part of the outer coil which likewise defines the space, thereby directly cooling both the stator core and the coils. This enables the stator core and the coils to be efficiently cooled. In this way, it is possible to provide the stator configured such that the stator core and the coils of the stator are efficiently cooled while the stator is manufacturable in a further simplified manner.

In the stator, the pair of side walls may have first projections configured to inhibit the outer coil from moving radially outward. This can suppress the outer coil from being shifted radially outward and entering the space, thereby maintaining the flow path volume of the in-core flow path.

In the stator, the pair of side walls may have second projections configured to inhibit an inner coil, arranged radially innermost among the coils in each of the plurality of slots, from moving radially inward. This can suppress the inner coil from being shifted radially inward and thus falling off from the slot, thereby reliably maintaining the coils in the slot.

The stator may include a guide member having a ring shape and arranged coaxially with the stator core on at least one side in an axial direction of the stator core, and the guide member may include an introduction part to which an externally supplied cooling medium is introduced, and a core connector which communicates with the introduction part and which is connected to an inflow port of the in-core flow path. With this configuration, at least part of the externally supplied cooling medium is introduced into the introduction part of the guide member and then flows as it is from the core connector into the in-core flow path in the stator core. Therefore, the at least part of the externally supplied cooling medium is supplied to the in-core flow path in a fresh state, a state where the externally supplied cooling medium has not drawn heat from another component of the stator. This enables the stator core and the coils to be more efficiently cooled.

As described above, the present disclosure can provide the stator configured such that the stator core and the coils of the stator are efficiently cooled while the stator is manufacturable in a further simplified manner.

### BRIEF DESCRIPTION OF THE DRAWINGS

FIG. 1 is a schematic longitudinal sectional view of part of a motor unit of a first embodiment;

FIG. 2 is a perspective view of a stator of the first embodiment;

FIG. 3 is an exploded perspective view of the stator of FIG. 2;

FIG. 4 is a schematic front view of part of a stator core of the first embodiment;

FIG. 5 is a schematic front view of part of an oil guide of the first embodiment;

FIG. 6 is a view illustrating a first flow pattern;

FIG. 7 is a view illustrating a flow of oil in a front oil guide and the stator core in the first flow pattern; and

FIG. 8 is a schematic front view of part of a stator core of a variation of the first embodiment.

### DETAILED DESCRIPTION

Embodiments of the present disclosure will be described with reference to the drawings below.

### First Embodiment

### Configuration of Motor Unit

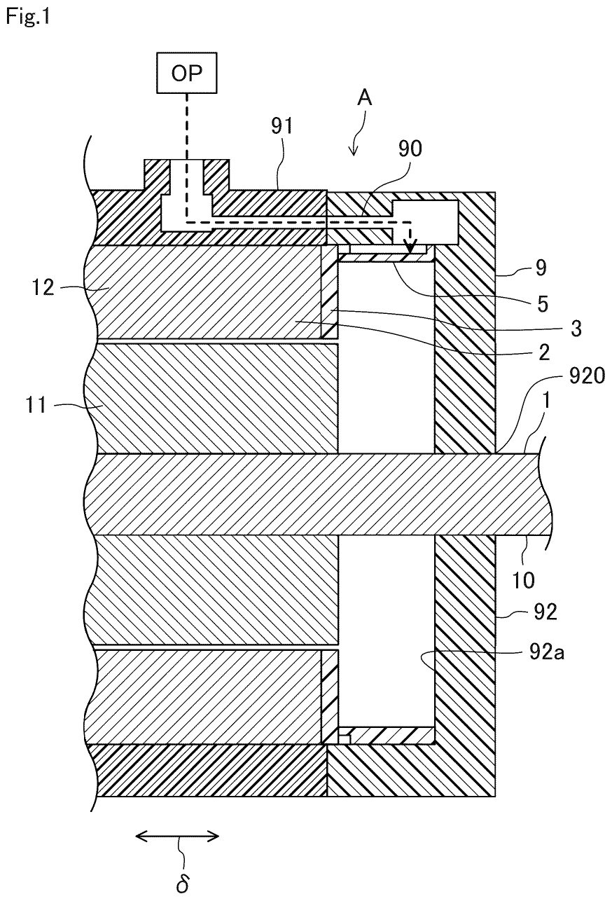

FIG. 1 is a schematic longitudinal sectional view of part of a motor unit A of a first embodiment. Note that FIG. 1 shows one end in an axial direction of the motor unit A, and the other end in the axial direction appears in a similar manner. First of all, the configuration of the motor unit A according to the first embodiment of the present disclosure will be described. As shown in FIG. 1, the motor unit A includes a motor 1 and a housing 9.

The motor 1 is, for example, an interior permanent magnet motor (IPM motor) and is used as a driving source of an electric vehicle. The motor 1 includes: a shaft 10 which constitutes a rotational axis; a rotor 11 having a circularly cylindrical shape with a center hole in which the shaft 10 is fixed; and a stator 12 having a circularly cylindrical shape and arranged radially spaced apart from the rotor 11 such that an inner circumferential surface of the stator 12 faces an outer circumferential surface of the rotor 11. The shaft 10 is rotatable together with the rotor 11 and relative to the stator 12. The shaft 10, the rotor 11, and the stator 12 are arranged concentrically with one another, and axial directions thereof are collectively denoted by 8 in the figures. The configuration of the stator 12 will be described in detail later.

The motor 1 is supplied with oil as a cooling medium. More specifically, oil stored in an oil pan (not shown) and cooled by a heat exchanger (not shown) is pumped by an oil pump OP to the motor 1. In FIG. 1, a bold dashed arrow conceptually shows a flow of the oil, and likewise, bold arrows and bold dashed arrows in the following figures show flows of the oil. After used to cool the motor 1, the oil is stored in the oil pan again.

The housing 9 houses the rotor 11 and the stator 12 while exposing both ends of the shaft 10. The housing 9 has a flow path 90 formed therein. Through the flow path 90, externally supplied oil flows to the motor 1. The housing 9 may have another flow path (omitted in the figure) for the oil, for example, a flow path through which the oil flows to another member (e.g., a bearing). The configuration of the housing 9 will be described in detail later.

### Configuration of Stator

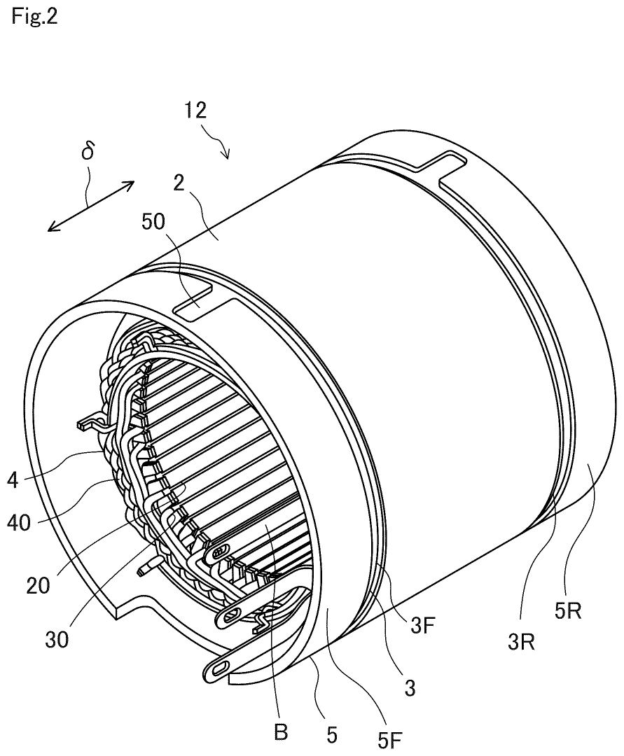

FIG. 2 is a perspective view of the stator 12 of the first embodiment. Subsequently, the configuration of the stator 12 according to the first embodiment of the present disclosure will be described in detail. As shown in FIG. 2, the stator 12 includes a stator core 2, an oil guide 3 (a guide member), coils 4 which are segment conductor (SC) windings of rectangular wires, and a sub-oil guide 5 (sub-guide member). The stator 12 is configured to allow a current to flow from a power supply (not shown) via an input terminal B to the coils 4, and the coils 4 serve as a main heat generation source of the stator 12. Thus, the stator 12 is configured to cool mainly the coils 4 by using the oil flowing from the flow path 90 of the housing 9. Each of the components of the stator 12 is described in detail below, and then, the flow patterns of the oil will be described.

### Each Component of Stator

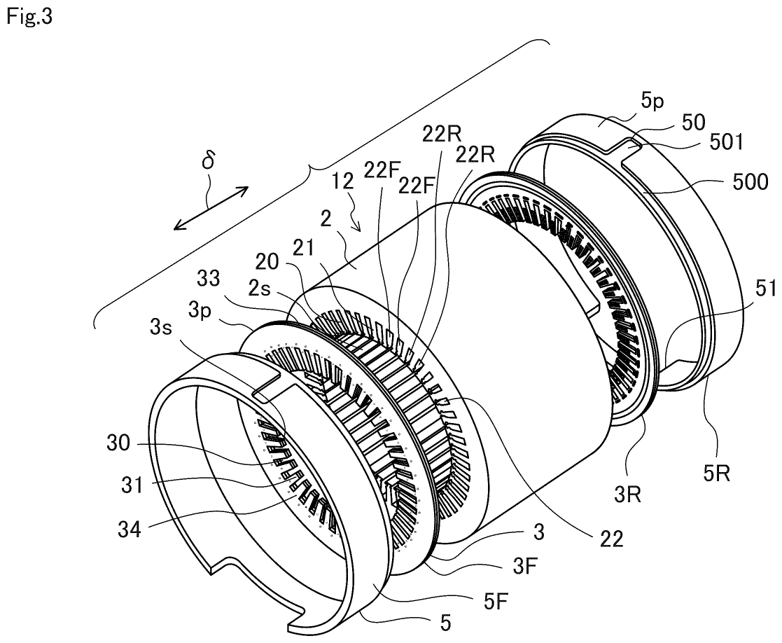

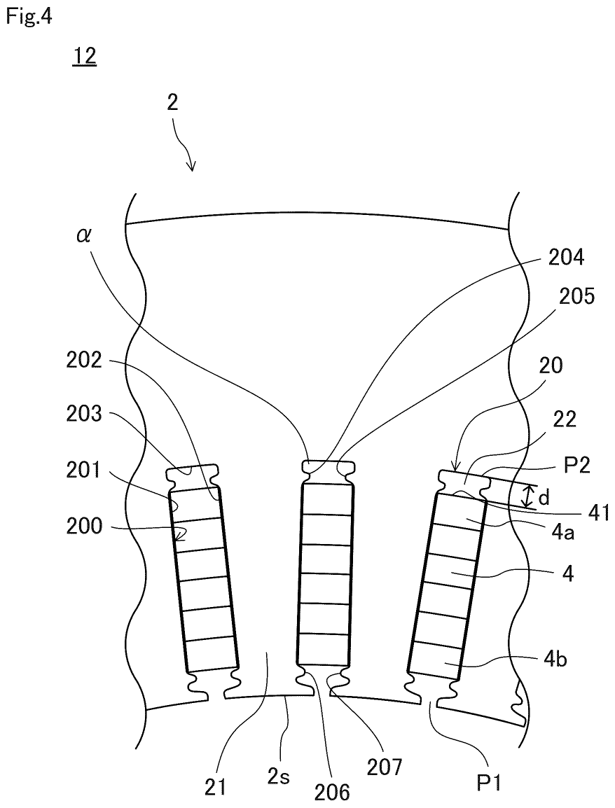

FIG. 3 is an exploded perspective view of the stator 12 of FIG. 2. Note that in FIG. 3, the coils 4 are not shown for the sake of illustration. FIG. 4 is a schematic front view of part of the stator core 2 of the first embodiment. As shown in FIG. 3, the stator core 2 has a circularly cylindrical shape and is made of magnetic material such as magnetic steel. As shown in FIGS. 3 and 4, the stator core 2 includes a plurality of first teeth 21 formed over the entire axial length of the stator core 2. The plurality of first teeth 21 extend circumferentially inward and are aligned side by side circumferentially. A space between adjacent ones of the plurality of first teeth 21 is a first slot 20 (slot). Thus, the stator core 2 has a plurality of first slots 20 axially penetrating the stator core 2 and disposed side by side circumferentially. Each first slot 20 extends radially outward from an inner circumference part 2s of the stator core 2 to open radially inward. The coils 4, which will be described in detail later, are inserted in the plurality of first slots 20, and as shown in FIG. 4, the coils 4 are arranged radially side by side in one line in the first slot 20.

As shown in FIG. 4, the first slots 20 each have inner walls 200 including: a pair of side walls 201 and 202 which extend radially outward from the inner circumference part 2s of the stator core 2 such that a corresponding one of the first slots 20 is open radially inward, the pair of side walls 201 and 202 circumferentially facing each other; and a bottom wall 203 connected to an end of each of the pair of side walls 201 and 202. Thus, an open part P1 is provided radially inner side of each first slot 20, and a closed part P2 closed by the side walls 201 and 202 and the bottom wall 203 is provided radially outer side of each first slot 20.

Also shown in FIG. 4, in each of the plurality of first slots 20, an outer coil 4a arranged radially outermost among the coils 4 is arranged radially apart (e.g., by about d=2 mm) from the bottom wall 203 such that a space α is formed between the bottom wall 203 and the outer coil 4a. The closed part P2 as described above is provided in each slot, and the outer coil 4a is arranged as described above, and thereby, the closed part P2 and a radially outside part 41 of the outer coil 4a define the space α.

The space α defined as described above forms an in-core flow path 22 through which the oil flows. More specifically, the in-core flow path 22 is the space α itself formed radially outside the outer coil 4a by defining an interior space of the first slot 20 by the outer coil 4a, and in the first slot 20, another member (e.g., a pipe) forming a flow path of the oil is not provided. Such spaces a form respective in-core flow paths 22 through which the oil flows, and thereby, without attaching another member in each of the first slots 20, the in-core flow paths 22 can be provided in the stator core 2. Thus, the stator 12 including the stator core 2 having the in-core flow paths 22 formed therein can be manufactured in a further simplified manner.

Moreover, if another member were to be attached in each of the first slots 20 to form a flow path of the oil in the stator core 2, damage could be caused to the inner wall 200 of the each of the first slots 20 when attaching said another member, and further, a reduction in strength of the stator core 2 due to the damage would be concerned. In this regard, the stator core 2 in which the spaces a constitute the respective in-core flow paths 22 as described above can avoid such damage and such a reduction in strength, and therefore, the stator 12 including the stator core 2 having the in-core flow paths 22 formed therein can be manufactured without influencing the strength of the stator core 2.

Further, the space α constitutes the in-core flow path 22, and therefore, the oil flowing through the in-core flow path 22 (space α) comes into contact with the stator core 2 at the closed part P2 defining the space α, and the oil comes into contact with the coils 4 at the radially outside part 41 of the outer coil 4a which likewise defines the space α, thereby directly cooling both the stator core 2 and the coils 4. Simply stated, the stator 12 is configured such that the oil flowing through the in-core flow path 22 (space α) directly cools both the stator core 2 and the coils 4. The space α thus constituting the in-core flow path 22 enables the stator core 2 and the coils 4 to be efficiently cooled.

As shown in FIG. 3, the in-core flow paths 22 include in-core flow paths 22F through which the oil flows axially forward and in-core flow paths 22R through which the oil flows axially rearward. The in-core flow paths 22F and 22R are provided in the first slots 20 for each two consecutive first slots 20 such that the in-core flow paths 22F and 22R are alternately aligned, two by two, circumferentially. For the sake of description, matters common to the in-core flow paths 22F and 22R may be described hereinafter by using common reference numeral 22.

In addition to the above configuration, as shown in FIG. 4, the pair of side walls 201 and 202 respectively have first projections 204 and 205 configured to inhibit the outer coil 4a from moving radially outward. The first projections 204 and 205 are arranged radially outside the outer coil 4a and protrude inward of the first slot 20 respectively from the side wall 201 and 202 to circumferentially face each other. The first projections 204 and 205 as described above can suppress the outer coil 4a from being shifted radially outward and thus entering the space α, thereby maintaining the flow path volume of the in-core flow path 22.

Further, in addition to the first projections 204 and 205, as shown in FIG. 4, the side wall 201 and 202 respectively have second projections 206 and 207 configured to inhibit an inner coil 4b, arranged radially innermost among the coils 4 in each first slot 20, from moving radially inward. The second projections 206 and 207 are arranged radially inside the inner coil 4b and protrude inward of the first slot 20 respectively from the side wall 201 and 202 to circumferentially face each other. The second protrusions 206 and 207 can suppress the inner coil 4b from being shifted radially inward and thus falling off from the first slot 20, thereby reliably maintaining the coils 4 in the slot.

As shown in FIGS. 2 and 3, the oil guide 3 includes an oil guide 3F and an oil guide 3R arranged on both sides in the axial direction of the stator core 2. The oil guide 3F is arranged on one side, i.e., on a front side, in the axial direction of the stator core 2. The oil guide 3R is arranged on the axially other end side, i.e., on a rear side, of the stator core 2. The oil guides 3F and 3R each have a ring shape having substantially the same outer diameter and inner diameter as those of the stator core 2 and are each arranged coaxially with the stator core 2. Both the oil guides 3F and 3R communicate via the in-core flow paths 22 with each other such that the oil passes through the in-core flow paths 22 of the stator core 2 from one of the oil guides to the other of the oil guides.

The oil guides 3F and 3R are arranged to face away from each other and have the same shape. Therefore, for the sake of description, matters common to the oil guides 3F and 3R may be described hereinafter by using common reference numeral 3.

The oil guide 3 is made of non-magnetic material, more specifically, resin material (e.g., syndiotactic polystyrene (SPS), polyphenylene sulfide (PPS)). As shown in FIG. 3, the oil guide 3 includes a plurality of second teeth 31 formed over the entire axial length of the oil guide 3. The plurality of second teeth 31 extend circumferentially inward to correspond one by one to the plurality of first teeth 21 of the stator core 2 and are aligned side by side circumferentially. A space between adjacent ones of the plurality of second teeth 31 is a second slot 30. Thus, the oil guide 3 has a plurality of second slots 30 axially penetrating the oil guide 3 to correspond one by one to the plurality of first slots 20. Each second slot 30 extends radially outward from an inner circumference part 3s of the oil guide 3 to open radially inward.

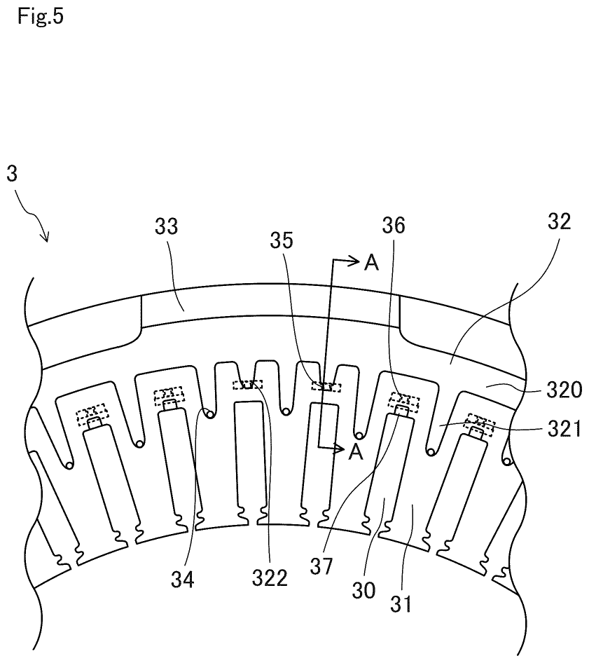

FIG. 5 is a schematic front view of part of the oil guide 3 of the first embodiment. As shown in FIG. 5, the oil guide 3 includes, in addition to a chamber 32 as an interior space and an introduction part 33 to which the externally supplied oil is introduced, a plurality of ejection parts 34, a plurality of first connectors 35 (core connectors), a plurality of second connectors 36, and a plurality of sub-ejection parts 37. Each ejection part 34 communicates via the chamber 32 with the introduction part 33 and is configured to eject the oil toward a coil end 40. Each first connector 35 communicates via the chamber 32 with the introduction part 33 and is connected to an inflow port of the in-core flow path 22, and each second connector 36 is connected to an outlet port of the in-core flow path 22 in the stator core 2. Each sub-ejection part 37 communicates with a corresponding one of the second connectors 36 and is configured to eject the oil flowing from another oil guide 3 toward the coil end 40. As shown in FIG. 5, the ejection parts 34 and the sub-ejection parts 37 are each a hole open axially outward and are provided in an axially outer part of the oil guide 3. In contrast, the first connectors 35 and the second connectors 36 are each a hole open axially inward and are provided in an axially inner part of the oil guide 3.

As shown in FIG. 5, the chamber 32 includes an annular part 320 and a plurality of branches 321. The annular part 320 is arranged to surround the second slots 30 from radially outside and is concentric. The plurality of branches 321 branch radially inward from the annular part 320 toward the interior of the second teeth 31. Each of the branches 321 is connected to an ejection part 34 or a first connector 35. A terminal part 322 which is a radially inside end of each branch 321 is rounded, and a terminal edge of the terminal part 322 of each branch 321 connected to the ejection part 34 is tangent to a terminal edge of the ejection part 34. That is, the chamber 32 is connected to the ejection parts 34 at terminal ends of the branches 321. The chamber 32 connected to the ejection parts 34 in such a manner eliminates a space in each branch 321 between an end side and its part connected to a corresponding one of the ejection parts 34. This can suppress air from accumulating at the terminal ends of the branches 321, thereby suppressing the ejection pressure of the oil from the oil guide 3 from decreasing.

Similarly to the case of the ejection parts 34 described above, the chamber 32 is connected to the first ejection parts 35 at terminal ends of the branches 321. This can suppress air from accumulating at the terminal ends of the branches 321, similarly to the case of the ejection parts 34 described above, thereby suppressing the inflow pressure of the oil to the in-core flow paths 22 from decreasing.

Referring back to FIG. 2, the coils 4 are inserted into the first slots 20 of the stator core 2 as described above and are also inserted into the plurality of second slots 30 of the oil guide 3, and thereby, the coils 4 are attached to the stator core 2 and the oil guide 3 such that a plurality of coil ends 40 axially protrude from the oil guide 3. The coils 4 are thus attached to the stator core 2 and the oil guide 3, and thereby, the oil guide 3 is arranged in the proximity of the coil ends 40 of the coils 4. Although not shown, the coils 4 are included in a plurality of (in the present embodiment, three) coil groups (corresponding to three phases) through which currents with different phases flow, and each coil 4 has an outer surface covered with an insulation coating.

As shown in FIGS. 2 and 3, the sub-oil guide 5 includes a sub-oil guide 5F and a sub-oil guide 5R which are arranged axially outside the oil guide 3. The sub-oil guide 5F is arranged forward of the oil guide 3F. The sub-oil guide 5R is arranged rearward of the oil guide 3R. The sub-oil guides 5F and 5R each have a cylindrical shape and are arranged coaxially with the oil guides 3F and 3R.

The sub-oil guides 5F and 5R are arranged to face away from each other and have the same shape. Therefore, for the sake of description, matters common to the sub-oil guides 5F and 5R may be described hereinafter by using common reference numeral 5.

The sub-oil guide 5 is made of non-magnetic material, more specifically, resin material (e.g., syndiotactic polystyrene (SPS), polyphenylene sulfide (PPS)). The sub-oil guide 5 has an outer circumference part 5p having a guide groove 50 and a cutout 51. The guide groove 50 is configured to receive the externally supplied oil and guide the oil to the oil guide 3. The cutout 51 is configured to discharge the oil, which has been used to cool the coil ends 40, from the stator 12.

As shown in FIG. 3, the guide groove 50 includes a circularly annular groove 500 and a straight groove 501. The circularly annular groove 500 has an axially inner end which lowers radially inward by one step toward the oil guide 3. The straight groove 501 extends axially outward from an upper part of the annular groove 500. The oil flowing from the flow path 90 of the housing 9 in FIG. 1 is dropped onto the straight groove 501 and then flows from the circularly annular groove 500 to the introduction part 33 of the oil guide 3, and the oil is used to cool the coil 4 and is then discharged from an inner circumference side of the sub-oil guide 5 through the cutout 51.

### Flow Pattern of Oil

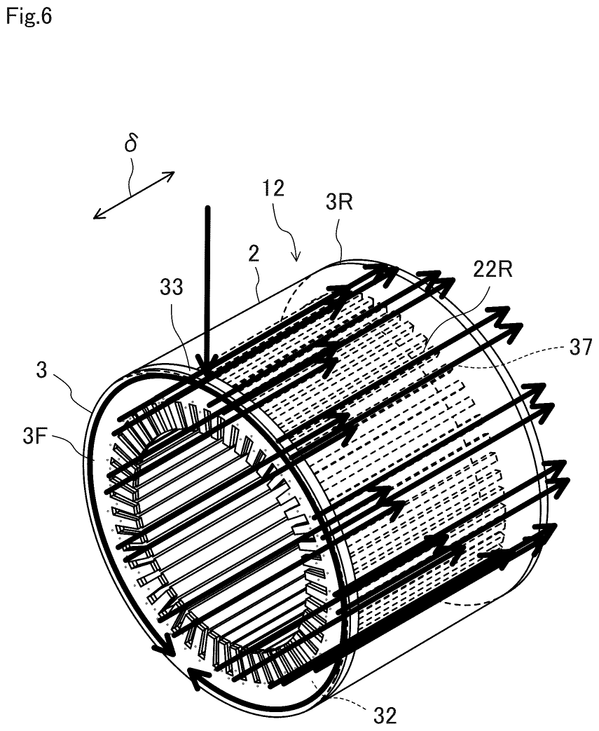

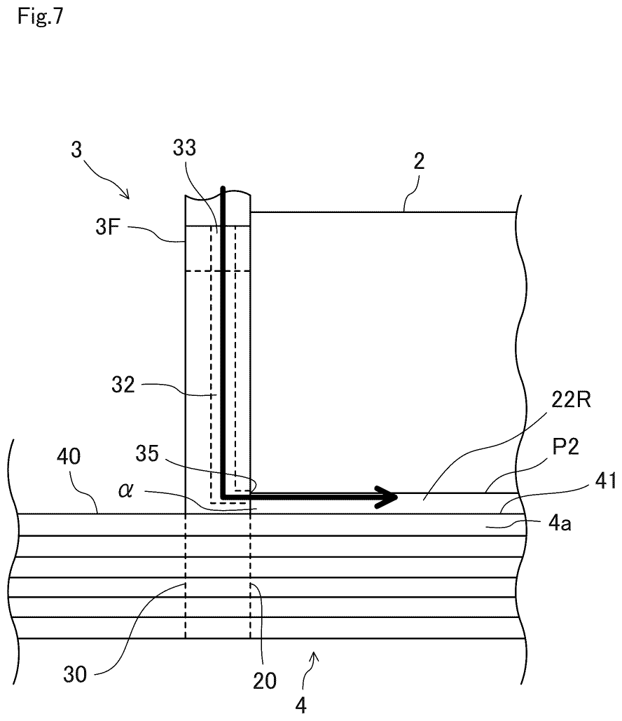

Then, the flow patterns of the oil cooling the coils 4 of the stator 12 will be described. FIG. 6 is a view illustrating a first flow pattern. Note that in FIG. 6, the coils 4 are not shown for the sake of illustration, and the first connectors 35 and the second connectors 36 do not appear. FIG. 7 is a view illustrating a flow of oil in the front oil guide 3F and the stator core 2 in the first flow pattern. Specifically, FIG. 7 shows a cross-sectional view along line A-A of FIG. 5. As shown in FIG. 6, the first flow pattern is a pattern of oil flowing from the front oil guide 3F through the in-core flow paths 22R in the stator core 2 to the rear oil guide 3R. More specifically, in the first flow pattern, the externally supplied oil is introduced to the introduction part 33 of the front oil guide 3F as shown in FIGS. 6 and 7, and then passes through the chamber 32 and the first connector 35 of the oil guide 3F and passes through the in-core flow paths 22R of the stator core 2, and thereafter further passes through the second connectors 36 in the rear oil guide 3R and is ejected from the sub-ejection parts 37 of the oil guide 3R toward the coil ends 40 on the rear side as shown in FIG. 6.

In the first flow pattern as described above, as shown in FIG. 7, the oil flowing through each in-core flow path 22R (space α) comes into contact with the stator core 2 at the closed part P2 defining the space α, and the oil comes into contact with the coils 4 at the radially outside part 41 of the outer coil 4a which likewise defines the space α, thereby directly cooling both the stator core 2 and the coils 4. This enables the stator core 2 and the coils 4 to be efficiently cooled.

Moreover, in the first flow pattern, as shown in FIG. 7, at least part of the externally supplied oil is introduced into the introduction part 33 in the front oil guide 3F and then flows as it is from the first connectors 35 into the in-core flow paths 22R of the stator core 2. Therefore, the at least part of the externally supplied oil is supplied to the in-core flow paths 22R in a fresh state, a state where the externally supplied oil has not drawn heat from another component of the stator 12. This enables the stator core 2 and the coils 4 to be more efficiently cooled.

Further, in the first flow pattern, the sub-ejection parts 37 of the rear oil guide 3R eject the oil passing from the oil guide 3F through the in-core flow paths 22R of the stator core 2 from the sub-ejection parts 37 of the oil guide 3R toward the coil ends 40 on the rear side. This enables the oil supplied for cooling the stator core 2 to be used without waste to cool the coil ends 40 on the rear side.

The second flow pattern is common with the first pattern described above, and the illustration thereof will thus be omitted, but in contrast to the first flow pattern, the second flow pattern is a pattern of oil flowing from the rear oil guide 3R through the in-core flow paths 22F in the stator core 2 to the front oil guide 3F. More specifically, in the second flow pattern, the externally supplied oil is introduced to the introduction part 33 of the rear oil guide 3R and then passes through the chamber 32 and the first connector 35 of the oil guide 3R, passes through the in-core flow paths 22F of the stator core 2, further passes through the second connectors 36 of the front oil guide 3F, and is ejected from the sub-ejection parts 37 of the oil guide 3F toward the coil ends 40 on the front side.

Also in such a second flow pattern, similarly to the first flow pattern, the oil flowing through each in-core flow path 22F (space α) comes into contact with the stator core 2 at the closed part P2 defining the space α, and the oil comes into contact with the coils 4 at the radially outside part 41 of the outer coil 4a which likewise defines the space, thereby directly cooling both the stator core 2 and the coils 4. This enables the stator core 2 and the coils 4 to be efficiently cooled.

Also in the second flow pattern, similarly to the first flow pattern, at least part of the externally supplied oil is supplied to the in-core flow paths 22F in a fresh state, a state where the externally supplied oil has not drawn heat from another component of the stator 12. This enables the stator core 2 and the coils 4 to be more efficiently cooled.

Further, also in the second flow pattern, similarly to the first flow pattern, the oil passing through the in-core flow paths 22F is ejected from the sub-ejection parts 37 of the oil guide 3F toward the coil ends 40 on the front side, and thereby, the oil supplied for cooling the stator core 2 is used without waste to cool the coil ends 40 on the front side.

### Configuration of Housing

Referring back to FIG. 1, the housing 9 includes: a body part 91 having a circularly cylindrical shape; and a pair of lids 92 each of which has a bottomed circularly cylindrical shape and which are arranged to close respective openings on axial ends of the body part 91. The bottom of each lid 92 has a hole 920 into which the shaft 10 is to be inserted. Each lid 92 is fixed to a corresponding one of the axial ends of the body part 91 with a fastener (not shown) such as a bolt.

In a state where each of the lids 92 is fixed to the body part 91, a bottom inner surface 92a of the each of the lids 92 is in contact with the sub-oil guide 5 arranged at the axial end of the stator 12 and presses the sub-oil guide 5 axially inward. In this state, the oil guide 3 arranged axially inside the sub-oil guide 5 is pressed by the lid 92 axially against the stator core 2 via the sub-oil guide 5. That is, the housing 9 is configured to press the oil guide 3 of the stator 12 axially against the stator core 2. With the housing 9 having the above-described configuration, the oil is suppressed from leaking from a location between the stator core 2 and the oil guide 3 without providing a sealing member, such as an O-ring, between the stator core 2 and the oil guide 3. This can reduce the number of components included in the motor unit A, thereby reducing the cost of the motor unit A.

According to the stator 12 described above, the space α defined by the closed part P2 and the radially outside part 41 of the outer coil 4a in each first slot 20 of the stator core 2 constitutes the in-core flow path 22, therefore, without attaching another member (e.g., a pipe) in each of the first slots 20, the in-core flow paths 22 can be provided in the stator core 2. Thus, the stator 12 including the stator core 2 having the in-core flow paths 22 formed therein can be manufactured in a further simplified manner.

The space α constitutes the in-core flow path 22, and therefore, the oil flowing through each in-core flow path 22 (space α) comes into contact with the stator core 2 at the closed part P2 defining the space α. the oil comes into contact with the coils 4 at the radially outside part 41 of the outer coil 4a which likewise defines the space α, thereby directly cooling both the stator core 2 and the coils 4. This enables the stator core 2 and the coils 4 to be efficiently cooled. In this way, it is possible to provide a stator 12 which enables the stator core 2 and the coils 4 to be efficiently cooled while the stator 12 is manufacturable in a further simplified matter.

### Variations

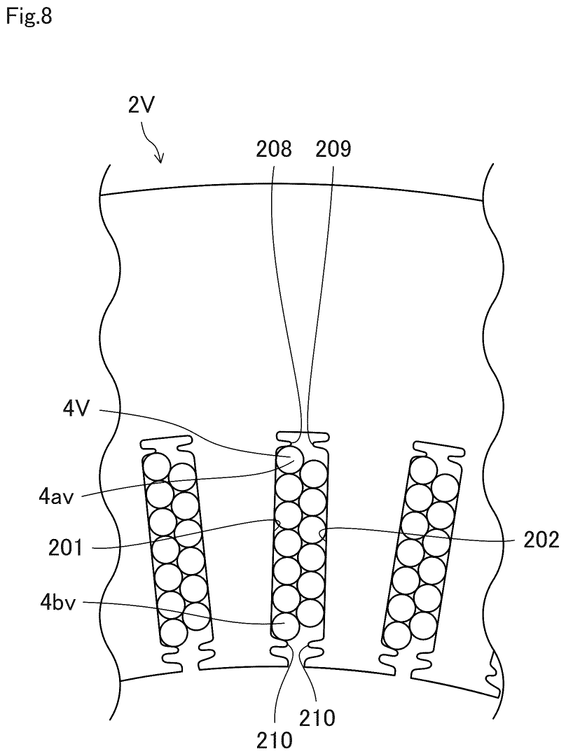

FIG. 8 is a schematic front view of part of a stator core 2 of a variation of the first embodiment. Note that the ratio of coils 4V and the like shown in FIG. 8 are not necessarily the same as the actual ones. The coils 4 are not limited to the example described above but may be coils other than the SC windings, for example, the coils 4V which are continuous windings as shown in FIG. 8. Taking into account that each coil 4V generally has a smaller peripheral circumference than the coil 4 which is the SC winding, and to reliably suppress an outer coil 4av, arranged radially outermost among the coils 4V, from entering a space α as shown in FIG. 8, the length (a circumferential dimension measured from side walls 201 and 202) of first projections 208 and 209 is preferably set to be longer than that of the first projections 204 and 205. Similarly, to reliably suppress an inner coil 4bv, arranged radially innermost among the coils 4V, from falling off from a first slot 20 as shown in FIG. 8, the length (a circumferential dimension measured from the side walls 201 and 202) of second projections 211 and 211 is preferably set to be longer than that of the second projections 206 and 207.

Note that liquid other than the oil may be employed as the cooling medium. Further, as components for allowing the oil to flow to the in-core flow paths 22 in the stator core 2, another component may be employed in place of the oil guide 3. In this case, the coils 4 can be attached to the stator core 2 by being inserted into the plurality of first slots 20 of the stator core 2. Moreover, the oil guide 3 may be provided at an axially one end of the stator core 2. Moreover, the oil guides 3F and 3R may have shapes different from each other.

Note that the examples described above should not be construed as limiting. The side walls 201 and 202 do not have to be provided with the first projections 204 and 205. As a component configured to inhibit the outer coil 4a from moving radially outward, another component may be employed in place of the first projections 204 and 205. Similarly, the side walls 201 and 202 do not have to be provided with the second projections 206 and 207. As a component configured to inhibit the inner coil 4b from moving radially inward, another component may be employed in place of the second projections 206 and 207.

Note that the oil guide 3 may be made of non-magnetic material, such as ceramics, other than resin material. Making the oil guide 3 of non-magnetic material allows the oil guide 3 to be provided for the stator 12 without magnetically influencing the motor 1.

The embodiments described above are examples in all aspects and should not be construed as limiting. Thus, the technical scope of the present invention should not be interpreted based on only the embodiments and the examples described above but is set forth based on the recitation of the claims. Moreover, modifications and variations belonging to the equivalent of the scope of the claims should all fall within the scope of the present invention.

While the present disclosure has been described with reference to embodiments thereof, it is to be understood that the disclosure is not limited to the embodiments and constructions. The present disclosure is intended to cover various modification examples and modifications within the range of equivalency. In addition, various combinations and configurations, and further, other combinations and configurations including more, less, or only a single element thereof are also within the spirit and scope of the present disclosure.

What is claimed is:

1. A stator comprising:
a stator core having a circularly cylindrical shape and having a plurality of slots axially penetrating the stator core, and
coils attached to the stator core by being inserted into the plurality of slots, wherein
the plurality of slots each have inner walls including:
a pair of side walls which extend radially outward from an inner circumference part of the stator core such that a corresponding one of the plurality of slots is open radially inward, the pair of side walls circumferentially facing each other; and
a bottom wall connected to an end of each of the pair of side walls,
in each of the plurality of slots, an outer coil arranged radially outermost among the coils is arranged radially apart from the bottom wall such that a space is provided between the bottom wall and the outer coil, and
the space forms an in-core flow path through which a cooling medium flows.

2. The stator of claim 1, wherein
the pair of side walls have first projections configured to inhibit the outer coil from moving radially outward.

3. The stator of claim 1, wherein
the pair of side walls have second projections configured to inhibit an inner coil, arranged radially innermost among in the coils in each of the plurality of slots, from moving radially inward.

4. The stator of claim 1, further comprising a guide member having a ring shape and arranged coaxially with the stator core on at least one side in an axial direction of the stator core, wherein
the guide member includes:
an introduction part to which the cooling medium which is externally supplied is introduced, and
a core connector which communicates with the introduction part and which is connected to an inflow port of the in-core flow path.
